(19) United States
(12) Patent Application Publication
(10) Pub. No.: US 2016/0208349 A1
(43) Pub. Date: Jul. 21, 2016

(54) METHOD FOR OPERATING A BLAST FURNACE

(71) Applicant: JFE STEEL CORPORATION, Tokyo (JP)

(72) Inventors: Daiki FUJIWARA, Tokyo (JP); Akinori MURAO, Tokyo (JP)

(73) Assignee: JFE STEEL CORPORATION, Tokyo (JP)

(21) Appl. No.: 14/915,300

(22) PCT Filed: Aug. 26, 2014
(86) PCT No.: PCT/JP2014/004380

§ 371 Date: Feb. 29, 2016

(30) Foreign Application Priority Data
Aug. 28, 2013 (JP) 2013-176537

(51) Int. Cl. C21B 5/00; C21B 7/16; F27D 3/18; F27B 1/16; F27D 3/16

(52) U.S. Cl. CPC C21B 5/003; F27B 1/16; F27D 3/16; F27D 3/18; C21B 7/16; F27D 2003/168; F27D 2003/185

(57) ABSTRACT

A method for operating a blast furnace that increases combustion temperature and reduces fuel consumption rate is provided. The method includes injecting hot air into the blast furnace from a tuyere. A solid reduction agent and at least one of a flammable reduction agent and a combustion-supporting gas are injected into the blast furnace, with the hot air, from the tuyere and through a lance. The solid reduction agent contains 65 mass % or less of particles whose particle diameter is greater than or equal to 75 μm. The method facilitates efficient mixing, accelerates the reaction between the pulverized coal and the combustion-supporting gas, and increases the temperature of the pulverized coal. Therefore, the combustion speed of the pulverized coal is increased, which increases the combustion temperature and reduces the reduction agent ratio.

### TECHNICAL FIELD

This application is directed to a method for operating a blast furnace that makes it possible to increase productivity and reduce reduction agent ratio by increasing combustion temperature as a result of injecting a solid reduction agent, such as pulverized coal, and a flammable reduction agent, such as LNG (liquefied natural gas), or a combustion-supporting gas, such as oxygen, from a blast furnace tuyere.

### BACKGROUND

In recent years, there becomes a problem global warming due to an increase in the amount of emission of carbon dioxide gas. Even in the steel industry, reducing the amount of emitted CO₂ is an important issue. Therefore, in recent years, operations of blast furnace are greatly encouraged which reduces a reduction agent ratio in a low level (“RAR” is abbreviated from the reduction agent ratio which represents the total amount of reduction agent that is injected from a tuyere and coke that is charged from the top of a furnace, per 1 ton of pig iron). In operations of blast furnaces, coke and pulverized coal are primarily used as reduction agents. In order to achieve the low reduction agent ratio, it is effective to replace coke and etc. with a material having a high hydrogen content, such as waste plastic, LNG, and heavy oil, or to increase the combustibility of the reduction agent.

In order to enhance the combustibility of pulverized coal that is injected as the reduction agent, Patent Literature 1 proposes that a burner for injecting a reduction agent from a tuyere be formed as a double wall burner, LNG be injected from an inner tube of the double tube, and pulverized coal be injected from a gap between the inner tube and an outer tube. Patent Literature 2 proposes that an injection nozzle for injecting a reduction agent from a tuyere be similarly formed as a double tube, pulverized coal be injected from an inner tube of the double wall nozzle, and LNG be injected from a gap between the inner tube and an outer tube. Patent Literature 3 proposes that two lances for injecting reduction agents be used, the lance for injecting pulverized coal as a solid reduction agent have a double wall structure, the pulverized coal be injected from an inner tube of the double wall lance, oxygen be injected from a gap between the inner tube and an outer tube, and LNG be injected from the other lance. Patent Literature 4 proposes that the combustibility of pulverized coal itself be enhanced by increasing the proportion of the pulverized coal whose particle diameter is 20 μm or less. Patent Literature

Patent Literature 1: Japanese Patent No. 3176680

Patent Literature 2: Japanese Examined Patent Application Publication No. 1-29847

Patent Literature 3: Japanese Unexamined Patent Application Publication No. 2013-40402

Patent Literature 4: Japanese Patent No. 4980110

### SUMMARY

### Technical Problem

The methods for operating a blast furnace described in Patent Literatures 1 to 3 are more effective for increasing combustion temperature and reducing reduction agent ratio than that of injecting only pulverized coal from a tuyere. But, these methods may not be sufficiently effective depending upon the particle size of pulverized coal and the speed of a carrier gas (transport gas) of pulverized coal. Specifically, as regards the former, the larger the particle size becomes and, as regards the latter, the higher the speed of the carrier gas becomes, the path of pulverized coal particles is separated from the flow of gases, such as LNG and oxygen. Therefore, mixing properties of pulverized coal with gases, such as LNG and oxygen, are reduced; as a result, the combustibility of pulverized coal is reduced. Patent Literature 4 proposes that the combustibility of pulverized coal itself be enhanced by increasing the proportion of the pulverized coal whose particle diameter is less than or equal to 20 μm. But, Patent Literature 4 does not consider the mixing properties with a flammable reduction agent and a combustion-supporting gas. Therefore, according to Patent Literature 4, there is still room for further improving the combustibility of a solid reduction agent (pulverized coal).

The disclosed embodiments have been made focusing on problems mentioned as the above. It is an object of the present disclosure to provide a method for operating a blast furnace that makes it possible to further increase combustion temperature and reduce reduction agent ratio.

### Solution to Problem

The disclosed embodiments include the following.
(1) A method for operating a blast furnace includes the steps of: injecting hot air into the blast furnace from a tuyere of the blast furnace; and injecting at least one of a flammable reduction agent and a combustion-supporting gas, and a pulverized solid reduction agent into the blast furnace from the tuyere through a lance along with the injecting of the hot air, wherein the solid reduction agent contains 65 mass % or less of particles whose particle diameter is greater than or equal to 75 μm.
(2) In the method according to the aforementioned (1) further includes, wherein the combustion-supporting gas has an oxygen concentration that is greater than or equal to 50 vol %, injecting from the lance part of oxygen which enriches the hot air.
(3) In the method according to the aforementioned (1) or (2), the solid reduction agent is pulverized coal.
(4) In the method according to any one of the aforementioned (1) to (3), the flammable reduction agent is any one of hydrogen, gas, LNG, propane gas, converter gas, blast-furnace gas, coke-oven gas, and shale gas.

### Advantageous Effects of Invention

According to the method for operating a blast furnace of the present disclosure, when a pulverized solid reduction agent and at least one of a flammable reduction agent and a combustion-supporting gas are injected from one lance, causing the mass proportion of particles whose particle diameter is greater than or equal to 75 μm to be less than or equal to 65 mass % of the total amount of the solid reduction agent that is injected from the lance, facilitates mixing efficiently at least one of the flammable reduction agent and the combustion-supporting gas injected from the lance efficiently with the solid reduction agent, and accelerates the reaction between the solid reduction agent and the combustion-supporting gas, or considerably increases the temperature of the solid reduction agent due to combustion heat of the flammable reduction agent. Therefore, the combustion speed of the solid reduction agent is increased, so that combustion temperature is considerably increased. Consequently, reduction agent ratio can be reduced.

### BRIEF DESCRIPTION OF THE DRAWINGS

FIG. 1 is a vertical sectional view of an exemplary blast furnace.

FIG. 2 illustrates a combustion state when only pulverized coal is injected from a lance in FIG. 1.

FIG. 3 illustrates a combustion mechanism of the pulverized coal in FIG. 2.

FIG. 4 illustrates a combustion mechanism when pulverized coal, LNG, and oxygen are injected.

FIG. 5 illustrates a specification of a lance used in an experiment.

FIG. 6 illustrates a flow of pulverized coal when the particle diameter of pulverized coal is greater than or equal to 75 μm.

FIG. 7 illustrates a flow of pulverized coal when the particle diameter of pulverized coal is less than 75 μm.

FIG. 8 illustrates a combustion experimental device.

FIG. 9 illustrates the relationship between pulverized coal particle diameter and pulverized coal combustion ratio in combustion experiment results.

### DETAILED DESCRIPTION

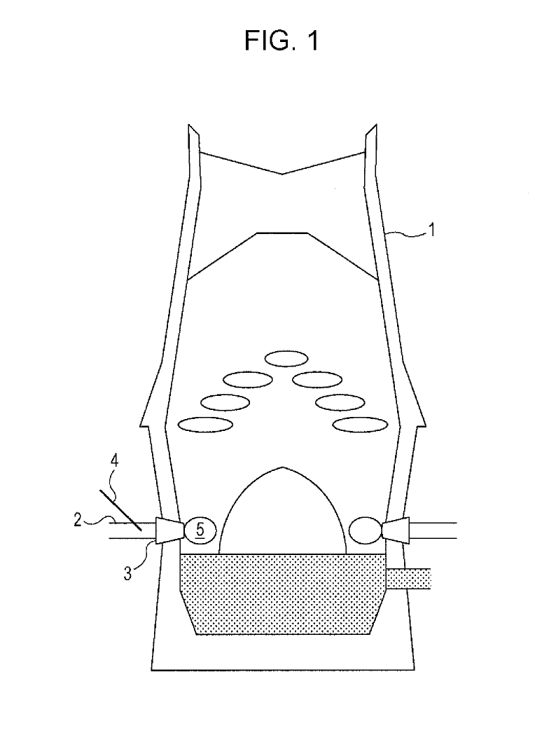

Next, a method for operating a blast furnace according to an embodiment of the present disclosure is described with reference to the drawings. The embodiment is hereunder described by using LNG as an example of a flammable reduction agent. FIG. 1 is an overall view of a blast furnace. In the blast furnace 1, coke and ore are fed from the top of the furnace, and the ore is reduced and melted, so that pig iron is produced. A blow pipe 2 is connected to a tuyere 3 that is formed at a lower portion of the blast furnace 1, and a lance 4 is inserted in the blow pipe 2 so as to extend through a side wall of the blow pipe 2. In operating the blast furnace, in a lower portion of an interior of the blast furnace 1, the coke is deposited, so that a coke deposit layer is formed. Hot air is sent to the tuyere 3 through the blow pipe 2 and pulverized coal is sent to the tuyere 3 from a lance 4. A combustion space which is called a raceway 5, is formed at the coke deposit layer located in front of the tuyere 3 in a direction in which hot air flows. In this combustion space, primarily, reduction agents, such as pulverized coal and coke, undergo combustion, and gasification of the reduction agents occurs. Although in FIG. 1 only one lance 4 is inserted into the blow pipe 2 on the left side of a side wall of the blast furnace 1, the lance 4 may be inserted into either one of the blow pipe 2 and the tuyere 3 circumferentially disposed along the side wall of the blast furnace 1. The number of lances 4 per tuyere 3 is not limited to one. Two ore more lances 4 may be inserted. As types of lances, a double wall lance, a triple wall lance, and a lance including a plurality of injection tubes are usable.

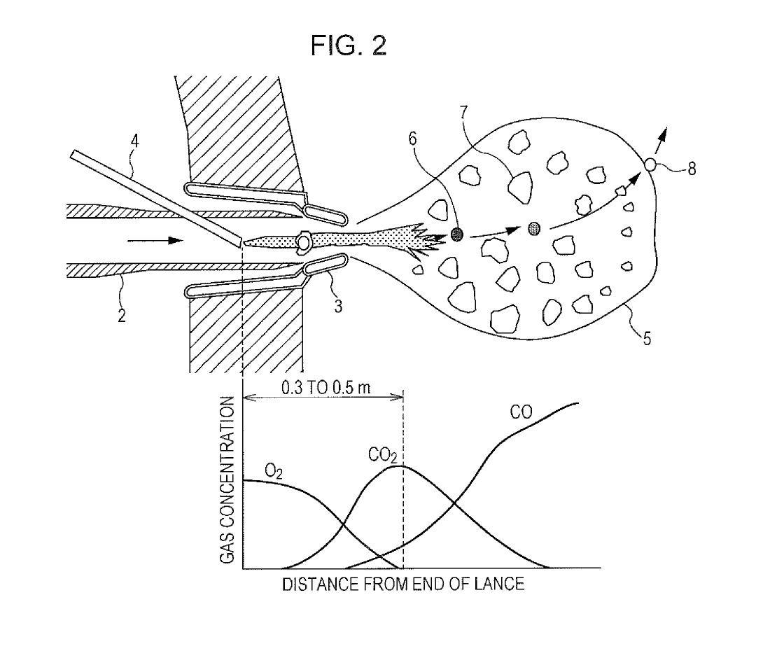

FIG. 2 illustrates a combustion state when only pulverized coal 6, serving as a solid reduction agent, is injected from the lance 4. The pulverized coal 6 passes through the tuyere 3 from the lance 4 and is injected into the raceway 5. Fixed carbon and volatile matter of the pulverized coal 6 undergo combustion along with coke 7. An aggregate of carbon and ash (generally called char) that could not undergo combustion is discharged as unburnt char 8 from the raceway 5. Hot blast velocity in front of the tuyere 3 in a direction in which hot air is sent (injecting direction) is approximately 200 m/sec, and the region of existence of O₂ in the raceway 5 from an end of the lance 4 is approximately 0.3 to 0.5 m. Therefore, it is necessary to virtually improve contact efficiency with O₂ (diffusibility) and raise the temperature of pulverized coal particles at a level of 1/1000 sec.

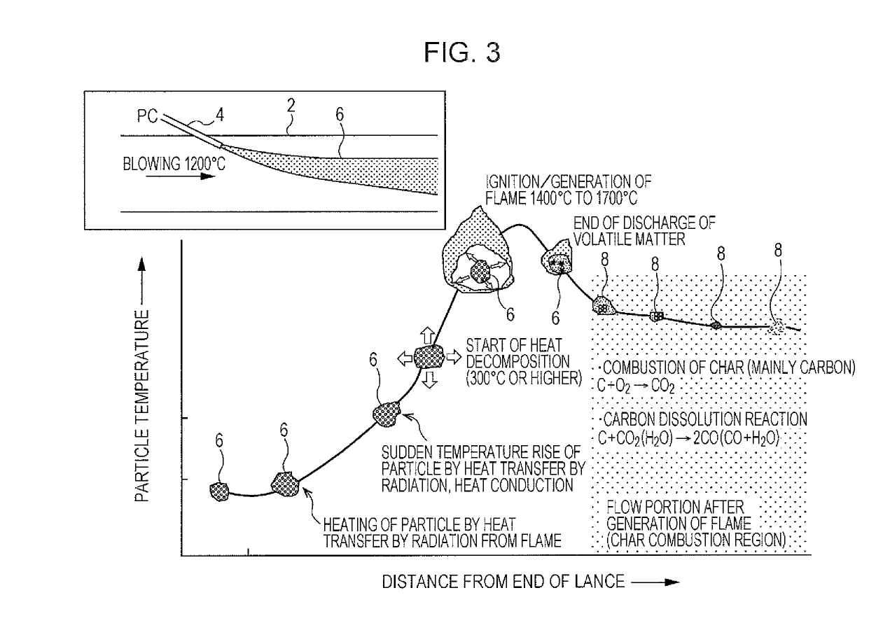

FIG. 3 illustrates a combustion mechanism when only the pulverized coal (in FIG. 3, PC) 6 is injected into the blow pipe 2 from the lance 4. The pulverized coal 6 is injected along with carrier gas (transport gas), such as N₂. The pulverized coal 6 has been injected into the raceway 5 from the tuyere 3. The pulverized coal 6 is first heated by heat transfer by convection from an air blast. Further, by heat transfer by radiation and heat conduction from a flame in the raceway 5, particle temperature is suddenly increased, and heat decomposition is started from the time when the temperature has been raised to at least 300° C., so that the volatile matter is ignited. This causes a flame to be generated, and combustion temperature reaches 1400 to 1700° C. If the volatile matter is discharged from the coal 6, the coal 6 becomes the aforementioned char 8. The char 8 is primarily fixed carbon, so that what is called a carbon dissolution reaction also occurs along with a combustion reaction. At this time, an increase in the volatile matter of the pulverized coal injected into the blow pipe 2 from the lance 4 facilitates ignition of the pulverized coal so that an increase in the combustion amount of the volatile matter raises the temperature rise rate and the maximum temperature of the pulverized coal. Therefore, the diffusibility and the temperature rise of the pulverized coal cause the reaction rate of char to increase. That is, it is thought that, as the volatile matter expands by gasification, the pulverized coal diffuses and the volatile matter undergoes combustion, so that, by combustion heat thereof, the pulverized coal is rapidly heated and its temperature is rapidly increased. As a result, for example, the pulverized coal undergoes combustion at a location that is close to a furnace wall.

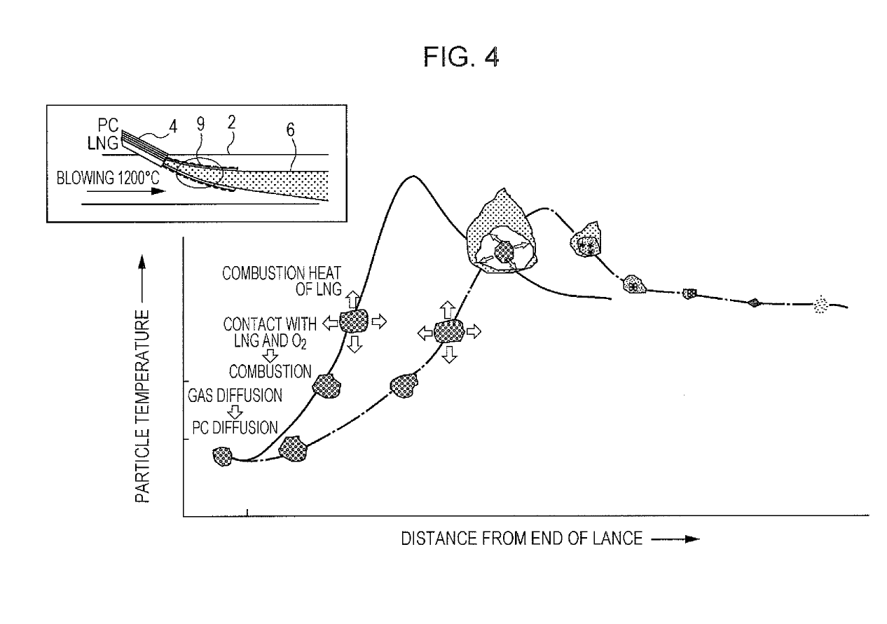

FIG. 4 illustrates a combustion mechanism when LNG 9 serving as a flammable reduction agent and oxygen O₂ serving as a combustion-supporting gas are injected along with the pulverized coal 6 into the blow pipe 2 from the lance 4. A way of injecting the pulverized coal 6, the LNG 9, and the oxygen O₂ is in case that they are simply injected in parallel. The alternate long and short dash line in FIG. 4 is shown with the particle temperature when only pulverized coal is injected as illustrated in FIG. 3 being used as a reference. It is thought that, when the pulverized coal, the LNG, and the oxygen are injected at the same time in this way, as gases including LNG and oxygen flow (indicated as “diffusion” in FIG. 4), the pulverized coal is diffused, and contact between the LNG and the O₂ causes the LNG to undergo combustion, as a result of which, by the combustion heat thereof, the pulverized coal is rapidly heated and its temperature is rapidly increased. This accelerates the ignition of the pulverized coal. Therefore, in order to enhance the combustibility of the pulverized coal, it is important that the pulverized coal be mixed without being separated from the flow of gases, such as the LNG and O₂.

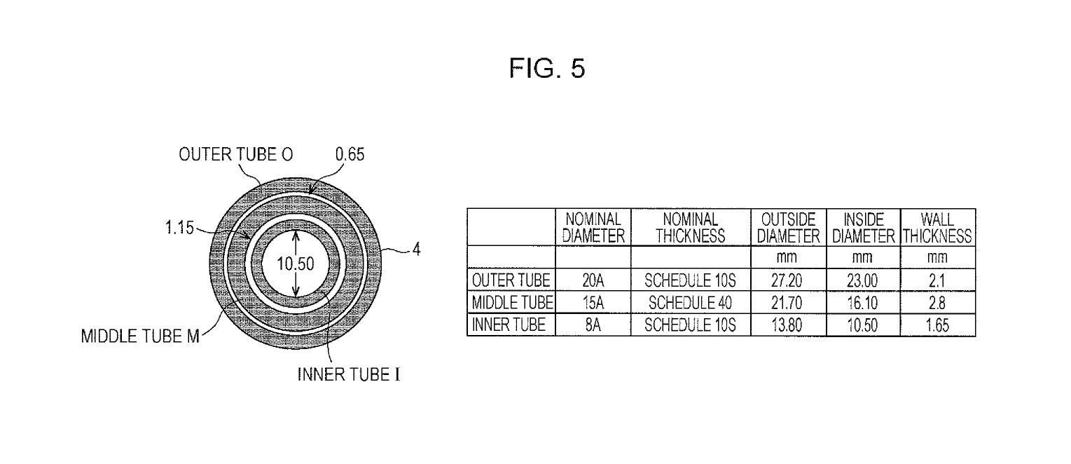

FIG. 5 illustrates an exemplary specification of the lance 4 for injecting pulverized coal, LNG, and oxygen at the same time. The lance 4 is a triple wall lance including an inner tube I, a middle tube M, and an outer tube O. In the triple wall lance 4, a stainless steel tube which has a nominal diameter of 8 A and a nominal thickness of schedule 10S is used as the inner tube I; a stainless steel tube which has a nominal diameter of 15A and a nominal thickness of schedule 40 is used as the middle tube M; and, a stainless steel tube which has a nominal diameter of 20 A and a nominal thickness of schedule 10S is used as the outer tube O. The specification of each stainless steel tube is as illustrated in FIG. 5. As a result, a gap between the inner tube I and the middle tube M is 1.15 mm, and a gap between the middle tube M and the outer tube O is 0.65 mm. A double wall lance that is described later is one without the outer tube of the triple wall lance, and a single wall lance is one including only the inner tube of the triple wall lance. If this triple wall lance is used, it is possible to blow out the pulverized coal from the inner tube I, the LNG or oxygen from the gap between the inner tube I and the middle tube M, and the oxygen or LNG from the gap between the middle tube M and the outer tube O.

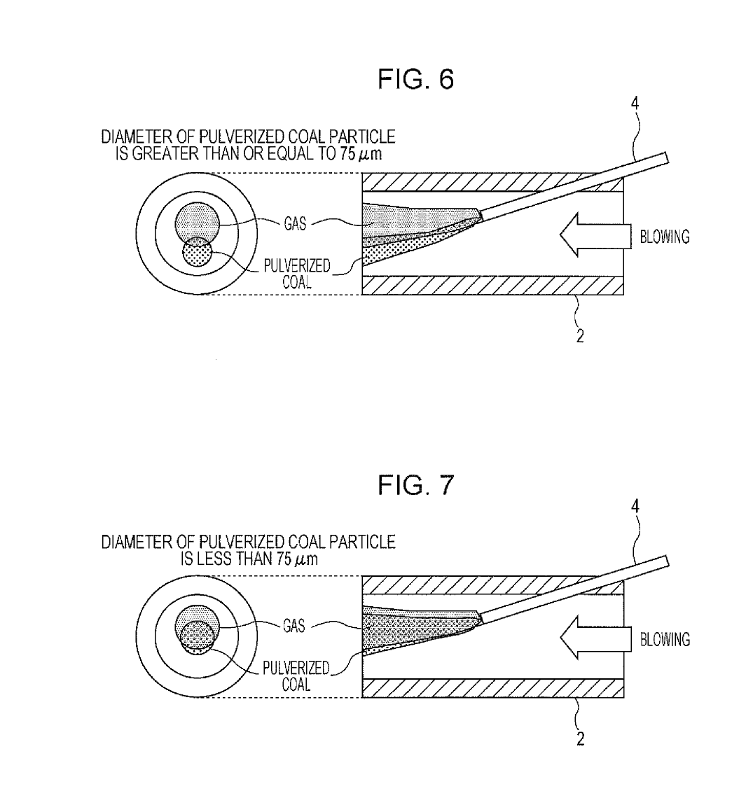

FIGS. 6 and 7 each illustrate a state of mixture of pulverized coal and gas in accordance with the particle diameter of the pulverized coal when the LNG 9 and oxygen are injected along with the pulverized coal 6 into the blow pipe 2 by using such a lance 4. FIG. 6 illustrates the case in which the pulverized coal particle diameter is greater than or equal to 75 μm, and FIG. 7 illustrates the case in which the pulverized coal particle diameter is less than 75 μm. A pulverized coal particle whose particle diameter is greater than or equal to 75 μm moves due to inertial force when the pulverized coal particle is injected into the furnace by carrier gas, whereas gases, such as LNG and oxygen, immediately follow an injection flow in the vicinity thereof. Therefore, the pulverized coal separates from the flow of gases. Consequently, in this case, it is thought that the effect of enhancing combustibility by injecting pulverized coal and LNG and oxygen at the same time is reduced. In contrast, it is thought that, since a pulverized coal particle whose particle diameter is less than 75 μm follows the injection flow in the vicinity thereof along with gases, such as LNG and oxygen, the pulverized coal particle is less likely to separate from the injection flow, so that the effect of enhancing combustibility by injecting them at the same time can be ensured.

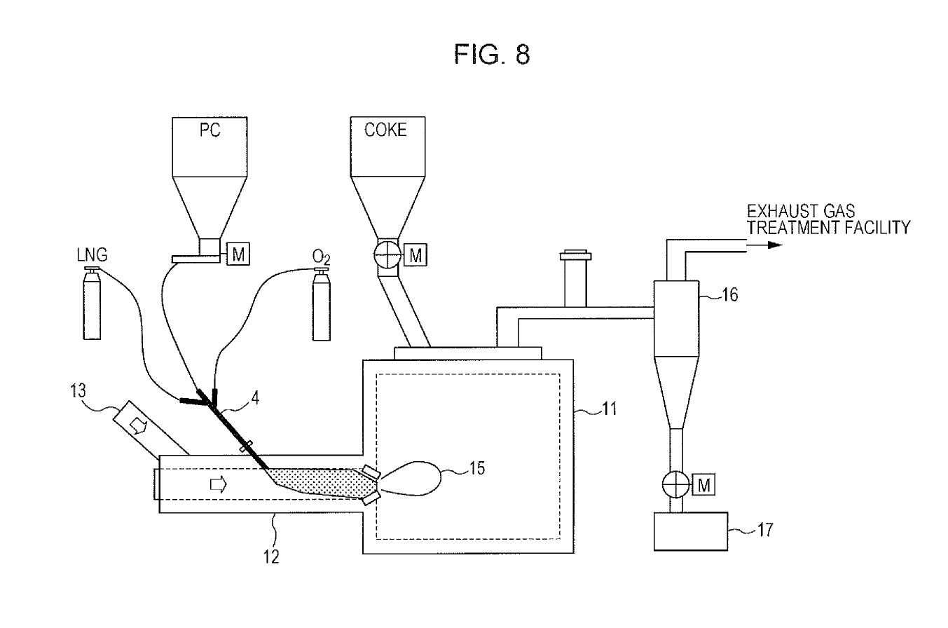

On the basis of such knowledge, a combustion experiment was conducted on pulverized coal supplied by the above-described lance 4. A combustion experimental device used in the combustion experiment is illustrated in FIG. 8. The combustion experimental device is a device for simulating an internal space at an end of the tuyere at the blast furnace 1. The combustion experimental device includes an experimental reactor 11 that is filled with coke and a blow pipe 12 that is connected to a tuyere formed in the experimental reactor 11. The blow pipe 12 is formed such that hot air is sent into the blow pipe 12. A combustion burner 13 is connected to the blow pipe 12. Accordingly, a predetermined amount of hot air generated by the combustion burner 13 can be sent into the experimental reactor 11, and, by sending the hot air into the experimental reactor 11, a raceway 15 is formed at an end of the tuyere. Further, a lance 4 is inserted into the blow pipe 12. From the lance 4, one or two or more of pulverized coal, LNG, and oxygen can be injected into the blow pipe 12; and the oxygen enrichment amount in the hot air that is injected into the experimental reactor 11 can be adjusted. The experimental reactor 11 is provided with a viewing window. An inner portion of the raceway 15 can be observed from the viewing window. A separator 16, which is called a cyclone, is connected to an upper portion of the experimental reactor 11 via a pipe. Exhaust gas that has been generated in the experimental reactor 11 is separated into exhaust gas and dust by the separator 16. The exhaust gas is sent to an exhaust gas treatment facility, such as an auxiliary furnace, and the dust is collected by a collecting box 17.

In the combustion experiment, as the lance 4, three types of lances, a single wall lance and a double wall lance and a triple wall lance, were used. Unburnt char was sampled at 300 mm from an end of each lance, and combustion rates were calculated for the respective following cases. These cases involves the case in which only pulverized coal was injected using the single wall lance; the case in which the double wall lance was used and pulverized coal was injected from an inner tube of the double wall lance, and LNG was injected from a gap between the inner tube and an outer tube; and, the case in which pulverized coal was injected from an inner tube of the triple wall lance, LNG was injected from a gap between the inner tube and a middle tube, and oxygen was injected from a gap between the middle tube and an outer tube. Unburnt chars were collected with a probe from the back of the raceway, and chemical analysis was performed on ash. The combustion rates were calculated by an ash tracer method. With the ash of char before and after the reaction being assumed as unchanging, a combustion rate η (%) of char was calculated by the following Formula (1) from a change in ash proportion;

$$\begin{matrix}[ Formula 1 ] & \\ η ( \% ) = 100 - \frac{( 100 - ash ) \times \frac{{ash}_{0}}{ash}}{100 - {ash}_{0}} \times 100 & ( 1 )\end{matrix}$$

where ash₀ represents an initial (before combustion) ash proportion (mass %) of pulverized coal, and ash represents an ash proportion (mass %) of sampled char.

Here, the pulverized coal contained 77.8 mass % of fixed carbon (FC), 13.6 mass % of volatile matter (VM), and 8.6 mass % of ash. The injecting condition was 51.0 kg/h (equivalent to 150 kg/t based on pig-iron-making unit consumption). The condition for injecting LNG was 3.6 kg/h (equivalent to 5 Nm³/h, 100 kg/t based on pig-iron-making unit consumption). The blowing conditions were: blowing temperature=1200° C., flow rate=300 Nm³/h, flow velocity=80 m/s, and O₂ enrichment+3.7 vol % (oxygen concentration of 24.7 vol %, enrichment of 3.7 vol % with respect to oxygen concentration of 21 vol % in air). In evaluating the experimental results, evaluations were made for the double wall lance and the triple wall lance, respectively, with reference to the combustion rate in the case in which only pulverized coal (N₂ used as carrier gas) was injected from the single wall lance. When O₂ was injected as combustion-supporting gas, part of the oxygen with which the air blast was enriched was used such that the total amount of the O₂ injected into the furnace did not change. As the combustion-supporting gas, air may be used. In the present disclosure, the combustion-supporting gas has an oxygen concentration that is greater than or equal to 50 vol %. This is because, if the oxygen concentration is at least 50 vol %, it is possible to cause a material other than the combustion-supporting gas to undergo combustion.

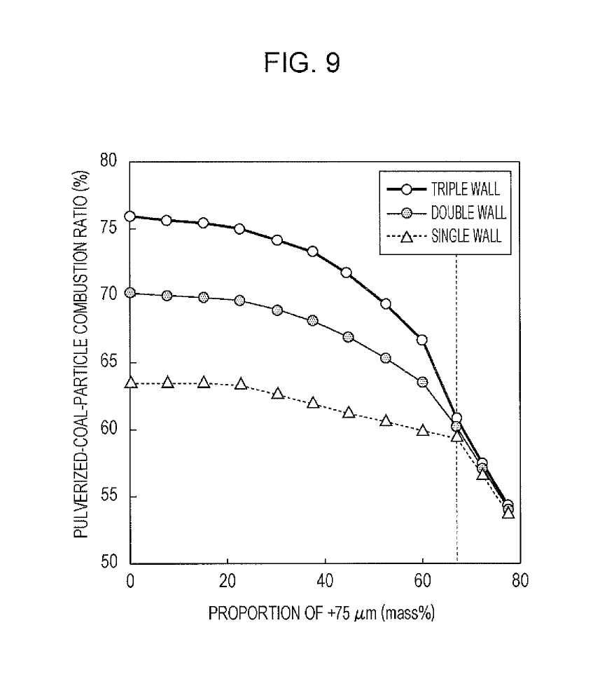

FIG. 9 shows the results of the above-described combustion experiment. FIG. 9 clearly shows that, when the mass proportion of pulverized coal whose particle diameter is greater than or equal to 75 μm is less than or equal to 65 mass % of the total amount of the pulverized coal injected from the lance, the effect of enhancing combustibility is provided for the double wall lance and the triple wall lance, and, in particular, the combustibility at the double wall lance and the combustibility at the triple wall lance are enhanced. It can be understood that, even in any of the single wall lance, the double wall lance, and the triple wall lance, when the mass proportion of the pulverized coal whose particle diameter is greater than or equal to 75 μm exceeds 65 mass %, the combustibility of pulverized coal is suddenly deteriorated. As mentioned above, it is thought that causing the mass proportion of the pulverized coal whose particle diameter is greater than or equal to 75 μm to be less than or equal to 65 mass % of the total amount of the pulverized coal provides the effect of enhancing combustibility due to injecting pulverized coal and LNG and oxygen at the same time without the flow of pulverized coal being separated from the gas flow of LNG and oxygen.

It is more preferable that the mass proportion of the pulverized coal whose particle diameter is greater than or equal to 75 μm be less than or equal to 20 mass %. FIG. 9 shows that, although the higher the mass proportion, the combustibility of the pulverized coal tends to be reduced, if the mass proportion is less than or equal to 20 mass %, the combustibility of the pulverized coal is maintained at a high value almost without a reduction in the combustibility of the pulverized coal.

When steel tubes are used as multiple tubes of the double wall lance 4, if the surface temperature of the multiple wall lance exceeds 880° C., creep deformation occurs, thereby causing the multiple wall lance to bend. Therefore, if cooling is performed by increasing cooling efficiency with the outlet flow velocity at the outer tube of the multiple wall lance being greater than or equal to 20 m/sec, the multiple wall lance is not deformed or bent. In contrast, if the outlet flow velocity at the gap between the outer tube and the inner tube of the double wall lance exceeds 120 m/sec, this is not practical from the viewpoint of operation costs of a facility. Therefore, the upper limit of the outlet flow velocity at the double wall lance is 120 m/sec. In this connection, since heat load on the single wall lance is less than that on the double wall lance, the outlet flow velocity is set at 20 m/sec or higher as necessary.

It is preferable to inject part of the oxygen with which hot air is enriched from the lance 4. This makes it possible to prevent an excessive supply of oxygen without losing the balance of the gases in the blast furnace.

Although, in the above-described embodiment, LNG is used as a flammable reduction agent, the flammable reduction agent according to the disclosed embodiments is not limited to only LNG. As flammable reduction agents other than LNG, it is preferable to use any one of hydrogen, urban gas, propane gas, converter gas, blast-furnace gas, coke-oven gas, and shale gas. Shale gas is a natural gas extracted from shale layers, and is an equivalent to LNG. Since shale gas is produced at places that are not existing gas fields, shale gas is called an unconventional natural gas resource. Flammable reduction agents, such as urban gas, are ignited/undergo combustion very rapidly. Flammable reduction agents having high hydrogen content have high combustion calorie. Unlike pulverized coal, in terms of ventilation and heat balance, flammable reduction agents are advantageous agents in that they do not contain ash.

Although, in the above-described embodiment, only pulverized coal is used as a solid reduction agent, the solid reduction agent according to the present disclosure is not limited to only pulverized coal. As the solid reduction agent, for example, pulverized waste plastic may be used.

Accordingly, in the method for operating a blast furnace according to the embodiment, when pulverized coal (solid reduction agent) 6 and at least one of the LNG (flammable reduction agent) 9 and oxygen (combustion-supporting gas) are injected from one lance 4, causing the mass proportion of particles of pulverized coal 6 whose particle diameter is greater than or equal to 75 μm to be less than or equal to 65 mass % of the total amount of the solid reduction agent facilitates efficiently mixing at least one of the LNG 9 and oxygen injected from the lance 4 with the pulverized coal 6, and accelerates the reaction between the pulverized coal 6 and the oxygen or considerably increases the temperature of the pulverized coal 6 due to the combustion heat of the LNG 9. Therefore, the combustion speed of the pulverized coal 6 is increased, so that combustion temperature is considerably increased. Consequently, reduction agent ratio can be reduced.

1. A method for operating a blast furnace, the method comprising:
injecting hot air into the blast furnace from a tuyere; and
while injecting the hot air into the blast furnace, injecting (i) at least one of a flammable reduction agent and a combustion-supporting gas and (ii) a pulverized solid reduction agent into the blast furnace from the tuyere and through a lance,
wherein the solid reduction agent contains 65 mass % or less of particles whose particle diameter is greater than or equal to 75 μm.

2. The method according to claim 1, further including injecting the combustion-supporting gas into the blast furnace,
wherein the combustion-supporting gas is an oxygen gas that enriches the hot air and has an oxygen concentration that is greater than or equal to 50 vol %.

3. The method according claim 1, wherein the solid reduction agent is pulverized coal.

4. The method according to claim 1, further including injecting the flammable reduction agent into the blast furnace;
wherein the flammable reduction agent is selected from the group consisting of hydrogen urban gas, LNG, propane gas, converter gas, blast-furnace gas, coke-oven gas, and shale gas.

5. The method according to claim 1, further including injecting the flammable reduction agent and the combustion-supporting gas into the blast furnace.

6. The method according to claim 5, wherein:
the solid reduction agent is pulverized coal,
the combustion-supporting gas is an oxygen gas, and
the flammable reduction agent is selected from the group consisting of hydrogen urban gas, LNG, propane gas, converter gas, blast-furnace gas, coke-oven gas, and shale gas.

7. The method according to claim 1, wherein the solid reduction agent contains 20 mass % or less of particles whose particle diameter is greater than or equal to 75 μm
